(19) United States
(12) Patent Application Publication
(10) Pub. No.: US 2025/0111643 A1
(43) Pub. Date: Apr. 3, 2025

(54) DEMAND DETECTION BASED ON QUERY IMAGES

(71) Applicant: Adobe Inc., San Jose, CA (US)

(72) Inventors: Michele Saad, Austin, TX (US); Irgelkha Mejia, River Edge, NJ (US)

(21) Appl. No.: 18/375,881

(22) Filed: Oct. 2, 2023

(51) Int. Cl. G06F 16/583; G06F 16/532; G06V 10/44; G06V 20/70

(52) U.S. Cl. CPC G06V 10/44; G06F 16/532; G06F 16/583; G06V 20/70

(57) ABSTRACT

Systems and methods for detecting object demands based on query images are provided. An image tagging module generates multiple image tags for a query image. An image content analyzer module analyzes the multiple query image tags based on a knowledge graph associated with an online platform to create query feature data. A theme identification module identifies one or more query themes based on aggregated query image feature data. A demand analysis module generates demand data indicating user demand for an object corresponding to the query theme by comparing the query theme to catalog data of the online platform.

### TECHNICAL FIELD

This disclosure relates generally to generative artificial intelligence (AI). More specifically, but not by way of limitation, this disclosure relates to demand detection based on query images.

### BACKGROUND

Digital platforms, such as search engines and various websites, provide search functions for users to search for content of interest. Most commonly, a user formulates a search query by typing keywords describing content of interest. Some platforms provide functionality for searching by image. For example, a user may generate and refine an image using generative image technology and then use that generated image as a search query. The digital platform can search its database and/or other the internet sources to identify content responsive to the query. Certain digital platforms can track and report search trends by analyzing user search queries for a period of time. The search trends can provide intelligence about user attention at a high level and guide platforms or stakeholders to make informed decisions.

### SUMMARY

Certain embodiments involve detection of user demand for an item based on query images. Generative image technology is used to generate a query image based on prompts input by a user, for example from a user computing device. The query image is provided to or generated by a demand detection server. The demand detection server processes the query image using image recognition technology and generates image tags describing the contents of the query image. The demand detection server analyzes the multiple image tags based on a knowledge graph associated with an online platform to obtain query image feature data comprising inferred semantics of the image tags. The demand detection server identifies one or more query themes based on aggregated query image feature data. The demand detection server detects user demand for at least one item by comparing the one or more query themes to catalog data of the online platform.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 depicts an example of a computing environment in which a demand detection server detects user demands on an online platform based on query images, according to certain embodiments of the present disclosure.

FIG. 2 depicts an example of a process for detecting user demands based on query images, according to certain embodiments of the present disclosure.

FIG. 3 is an example workflow of detecting user demands on an online platform, according to certain embodiments of the present disclosure.

FIG. 4 depicts an example of a GUI for an online platform for entering a user query, according to certain embodiments of the present disclosure.

FIG. 5 depicts an example of a GUI for generating query images, according to certain embodiments of the present disclosure.

FIG. 6 depicts an example of a GUI for providing feedback on generated query images, according to certain embodiments of the present disclosure.

FIG. 7 depicts an example of a GUI showing a case in which the online platform 306 does not offer products that match or are sufficiently similar to generated or regenerated query images.

FIG. 8 depicts an example of a computing system for implementing certain embodiments of the present disclosure.

### DETAILED DESCRIPTION

The present disclosure provides techniques for analyzing query images to detect unmet demand for an item offered via an online platform. Online platform operators are constantly evolving their catalogs and associated inventories to keep up with popular trends and ever-changing user demands to maintain and expand user base. Curating an online catalog is generally labor intensive, and also requires expertise, insight, and understanding of user behaviors. Further, identifying items that users are searching for but not finding on the platform is critical to inform what items to add to the operator's catalog. This process generally requires manually sifting through scattered data, including keywords input by users to formulate their searches. Analysis of keywords presents limitations because the users' chosen keywords may not best describe the items the users have in mind.

In an embodiment of the present disclosure, a demand detection server can detect user demand based on query images submitted to an online platform. The online platform queries its catalog, e.g., inventory or database, to determine whether it includes items that match objects shown in the query image and displays the search results (or lack thereof) to the user. The online platform also provides the query image to a demand detection server for processing and analysis. The query image is processed and tagged by the demand detection server to indicate objects depicted in the image. The image tags are analyzed based on a knowledge database (e.g., knowledge graph) associated with the online platform's catalog to generate query image feature data, including inferred semantic descriptions of the image tags. The semantic descriptions identify context for and attributes of the image tags. The resulting query image feature data is stored in a data store for further analysis by the demand detection server.

In one example, the online platform is a marketplace platform offering certain products. As the demand detection server processes and analyzes query images, query image feature data is clustered to identify themes common among query images. Each query theme corresponds to a pattern or trend in shopper demand. Query themes are compared with the catalog data from the online platform to detect demand. For example, a query theme may be “teal-colored women's apparel,” as a result of a significant number of query images depicting teal-colored clothing for women. Another query theme derived from the same set of query images may be “short sleeve women's shirts,” as a result of a number of the query images showing women in short sleeve shirts. If the catalog data from the online platform does not include teal-colored women's clothing, particularly teal-colored short sleeve women's shirts, or short sleeve women's shirts in a sufficient variety of color, the demand detection server would determine there is a demand for such clothing. As more query images are processed by the demand detection server more query image feature data can be obtained and further aggregated to determine whether demand continues to be met or unmet and/or whether additional demand is present.

Demand data can be transmitted or displayed to the operator of the online platform. The operator of the online platform may decide to add items to the online platform catalog in response to demand data indicating a sufficiently high level of unsatisfied demand for the products. When an item is added to the online platform catalog, the online platform can generate and send notification messages to users who previously searched for items similar to the newly added item. Following the above example, after receiving the demand data, the operator of the online platform adds some long sleeve and short sleeve teal-colored women's tops to its catalog, as well as short sleeve women's shirts in additional colors to those previously offered. The online platform then sends notification messages to users who submitted query images that included teal-colored women's tops within a certain time period, such as within at least the past two weeks, notifying them of the new products offered by the online marketplace platform.

Certain embodiments of the present disclosure overcome the disadvantages of the prior art, by detecting demand for items offered on an online platform based on query images submitted to the online platform. The employed process automatically processes query images to identify and tag objects depicted therein. In some embodiments, the image tags are analyzed in the context of a knowledge graph to infer semantics of the image tags representing features of the objects depicted in the query images. Clusters of query image feature data are used to identify trends of user demand that the online platform has not met. The operator of the online platform does not need to sift through data from different sources, including keyword histories, to manually identify what products are in demand but not offered on the online platform and determine what kinds of products, either existing or new, to add to the online platform catalog. Meanwhile, the demand detection server enables the online platform to notify users who searched for certain products when the products are added to the online platform catalog. Overall, the processes employed by the demand detection server more accurately and quickly identify user demands and improve user engagement and conversion for the online platform.

As used herein, the term “query image” is used to refer to an image or picture that features an object of interest to a user. For example, a query image may be a synthetic image featuring at least one object corresponding to prompts input by a user to an image generative AI model. A query image is generated by or submitted to an online platform and is used by the online platform as the basis for a database search to identify items that are the same as or similar to the objects shown in the query image.

As used herein, the term “image tag” or “image tags” is used to referred to metadata or other data associated with an image that identifies object categories, object names, or object attributes associated with an object identified in an image. For example, a rubber duck is identified in an image, and the image tags for that image can include “rubber duck,” “yellow,” “duck,” etc.

As used herein, the term “catalog data” is used to refer to information related to items offered by an online platform, for example an inventory of products offered by an online merchant. The catalog data can include images and descriptions of the offered items.

As used herein, the term “knowledge graph” or “knowledge database” refers to a particular type of graph-based data model including interlinked descriptions of real-world entities (e.g., object, events, etc.). A knowledge graph can encode the semantics of the terminologies used in the knowledge graph to enable search, recommendation, and analysis. A knowledge graph can be built by a third party for a field or market sector with which the online platform is associated. Alternatively, the knowledge graph can be built by the online platform itself. For example, a marketplace platform can include functionality to build a product knowledge graph for products that are or can be offered by the online platform based on product data extracted from various product manufacturers, industry organization, and any suitable entities.

As used herein, the term “query image feature data” is used to refer to semantic descriptions of image tags associated with a query image, such as whether the image tags refer to a particular product or indicate an attribute such as a measurement or color, whether the image tags indicate an object in a query image is a component of a larger item, etc. For example, from image tags “rubber duck” and “yellow,” query image feature data “toys,” “bathtub toys,” “rubber duckie” can be inferred, in addition to “rubber duck” and “yellow.”

As used herein, the term “query theme” refer to one or more object categories reflected in a collection of query images. The query themes are identified by clustering query image feature data to identify commonalities, such as the same of similar object types or attributes. The query themes emerge when query images associated a specific object type or attribute are received from different users are above a threshold percentage of the overall queries. For example, if about 10% of all the query images submitted to the online platform during a particular timeframe are associated with teal-colored women's tops, “teal-colored women's tops” is the query theme and the query cluster associated with that query theme is the 10% of all query images directed to the online platform during such time frame.

As used herein, the term “demand data” is used to refer to data representing user demand for an item, such as a product, service, or other object, that is or could be offered on an online platform. Demand data is generated by a demand analysis module of a demand detection server. The demand data includes data indicating whether the user demand is met or unmet by an online platform. For example, the demand detection server determines a user demand for a product on an online platform based on the query images and query results. If the query results show no matching to the query images, the demand data indicates the user demand is unmet and displays or provides a notice to the platform operator. In some embodiments, the notice is in the form of a recommendation of certain products by certain suppliers that match the detected user demand. If the query results show matching products offered on the online platform and good user conversion, the demand data indicates the user demand is met and recommends the online platform keep the product in stock.

As used herein, the term “generative artificial intelligence,” “generative AI,” or “generative AI model” is used to refer to a type of AI system capable of generating text, images, or other media in response to prompts. Examples of image or art generative AI systems include Stable Diffusion, Midjourney, DALL-E, and similar machine learning models.

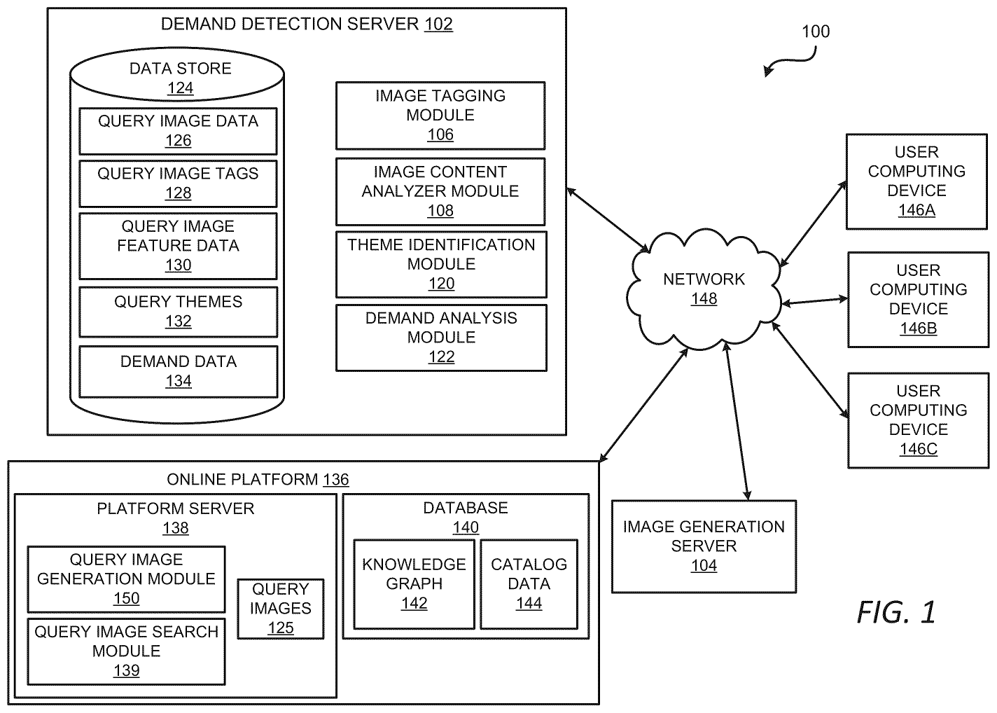

Referring now to the drawings, FIG. 1 depicts an example of a computing environment 100 in which a demand detection server 102 detects user demand for items offered or not offered by an online platform 136 based on query images 125, according to certain embodiments of the present disclosure. In various embodiments, the computing environment 100 includes a demand detection server 102 connected with an online platform 136, and user computing devices 146A, 146B, and 146C (which may be referred to herein individually as a user computing device 146 or collectively as the user computing devices 146) via a network 148. The computing environment may optionally include an image generation server 104 accessible by user computing devices 146 or the platform server 138. A user computing device 146 can be a desktop computer, a laptop computer, a tablet, a smart phone, or any suitable computing device. The network 148 may be a local-area network (“LAN”), a wide-area network (“WAN”), the Internet, or any other networking topology known in the art that connects the user computing device 146 to the online platform 136.

The online platform 136 includes a platform server 138 and a database 140. Examples of the online platform 136 can include marketplace platforms offering certain products or services, or any other suitable online platform that offers items to users. The database 140 stores catalog data 144. The catalog data 144 can include images of and descriptions for items offered on the online platform. The platform server 138 includes a query image search module 139 that receives query images 125 and performs searches of the catalog data 144 to identify any products, services or other items in the online platform provider's catalog that match, substantially match, or are otherwise similar to the objects depicted in the query images 125. In the context of the invention, offering items on an online platform 136 can mean offering for sale, rent, trade, give-away, etc.

In some embodiments, the platform server 138 executes a query image generation module 150 that generates one or more query images 125 in response to prompts entered by a user. Prompts may be freeform text input by the user or may be pre-defined descriptions selected by the user, e.g., via drop-down menus or other interactive graphical user interface items. User computing devices 146 may upload locally generated or captured query images 125 to the online platform 136. Alternatively, or additionally, user computing devices 146 can communicate with an image generation server 104, which executes a query image generation module 150, to generate query images 125 in response to prompts submitted via the user computing devices 146. A query image generation module 150 can be or can execute a pre-trained image generative AI model configured to generate images based on prompts. The pre-trained image generative AI model can be retrained or fine-tuned based on specific requirements of the online platform 136 and/or the demand detection server 102.

In some embodiments, the query image(s) 125 can be displayed to the user, for example in juxtaposition with the query search results. The user can provide feedback regarding a query image 125 or certain aspects of a query image 125. Feedback may be in the form of comments or an indication of “favorite,” “not a match,” “like” or “dislike” of the query image 125. In some embodiments, the feedback may be in the form of edits to the query image 125, which result in new prompts being submitted to the query image generation module 150 for generating a new query image 125. For example, the original query image 125 may show a short sleeve women's shirt and the user may indicate a desired to change the sleeve length. As a result, the query image generation module 150 receives new prompts that lead to the generation of a new query image 125 showing a long sleeve women's shirt. In another example, the user may edit or change to prompts used to generate the original query image 125.

Data can also be collected based on a user's interactions with the displayed search results, e.g., images of any relevant items offered by the online platform 136. For example, the user clicks an image to add the associated item to a shopping cart and/or is redirected to a webpage for purchasing the item. The user can also interact with the online platform 136 in other ways, such as by browsing the webpage, navigating away from the webpage, closing the webpage, searching for new items, etc. User feedback and other data collected in relation to the query images and data relating to user interactions with the online platform can be stored as metadata or other data structures associated with the query images 125. Query images 125 and any associated data (e.g., user feedback data, user interaction data, query result) are transmitted to the demand detection server 102 as query image data 126.

In some examples, the database 140 stores a knowledge graph 142 associated with the online platform 136. The knowledge graph 142 includes information about items offered on the online platform 136. The knowledge graph 142 can be generated by the online platform 136 or a third party (not shown). In some examples, the knowledge graph 142 is stored on a third-party platform and can be accessed via an API by the platform server 138 and/or the demand detection server 102, whether the knowledge graph is created by the online platform 136 or not. The knowledge graph 142 is used by the query image search module 139 to perform searches of the catalog data 144 based on the query images 125.

Query images 125 are received (as part of the query image data 126) and processed by the demand detection server 102, which includes an image tagging module 106, an image content analyzer module 108, a theme identification module 120, a demand analysis module 122, and a data store 124. The image tagging module 106 is configured to recognize the object(s) in a query image 125 and generate query image tags 128 based on the object recognition. The query image tags 128 can include one or more object categories, one or more object names, and one or more object attributes. The image tagging module 106 can implement a machine learning (ML) algorithm to recognize the object and generate tags (or labels) describing the object. The query image tags 128 associated with a generated query image 125 can be stored in the data store 124.

The image content analyzer module 108 is configured to analyze the multiple query image tags 128 based on a knowledge graph 142 associated with the online platform 136 to obtain query image feature data 130. In some examples, the image content analyzer module 108 maps the query image tags 128 associated with a generated query image to the knowledge graph 142 and determines a semantic context of the query image tags 128 to obtain inferred semantic descriptions of the multiple image tags. The image content analyzer module 108 extracts the inferred semantic descriptions (e.g., inferred object categories, inferred object names, and inferred object attributes) from the knowledge graph 142 to create the query image feature data 130. In some embodiments, the image content analyzer module 108 accesses the database 140 of the online platform 136 to retrieve or query the knowledge graph 142. In other embodiments, the knowledge graph 142 is transmitted to the demand detection server for use by the image content analyzer module 108. Query image feature data 130 associated with different query images 125 generated for different user queries can be aggregated and stored in the data store 124.

The theme identification module 120 is configured to identify query themes 132 from the query image feature data 130 aggregated from query images 125 generated for user queries during a period of time. The theme identification module 120 can implement a clustering model to cluster query image feature data 130 corresponding to different query images 125 to one or more query clusters. A query theme 132 can be extracted from the query image feature data 130 corresponding to a query cluster. The query theme 132 can be associated with an object category, an object name, or an object attribute. The query themes 132 can be stored in the data store 124.

The demand analysis module 122 is configured to detect a user demand by comparing the one or more query themes 132 to catalog data 144 of the online platform 136 to generate demand data 134. In some examples, the demand analysis module 122 uses a similarity model to determine a similarity between an identified query theme 132 to the catalog data 144 of the online platform by calculating a similarity score. If the similarity is above a threshold, it determines that the online platform 136 meets the demand related to the identified query theme 132. If the similarity is below the threshold, it indicates that there is an unmet demand from the users of the online platform 136. In some embodiments, demand data 134 can include synthetic images representing any items that are in demand by users of the online platform 136, be it met or unmet demand. In some embodiments, the demand data 134 can also include a recommendation whether to take actions to meet the unmet demand or continue meeting the demand. The demand data 134 can be stored in the data store 124.

In some embodiments, the demand analysis module 122 transmits the demand data 134 to the online platform 136. In other embodiments the demand data 134 is displayed for viewing by the operator of the online platform 136 via a graphical user interface of the demand detection server 102. When an item is added to the online platform 136, e.g., a product is added to the online platform operator's catalog, to meet a need identified in the demand data 134, the demand analysis module 122 can detect or be alerted to the change and may send a notification message to a user about the newly added object matching an object that the user previously searched for. In other embodiments, the online platform 136 may provide functionality for generating such notification messages. For example, the online platform 136 may offer the user an option to submit an email address at which the user wishes to receive notification messages regarding new products.

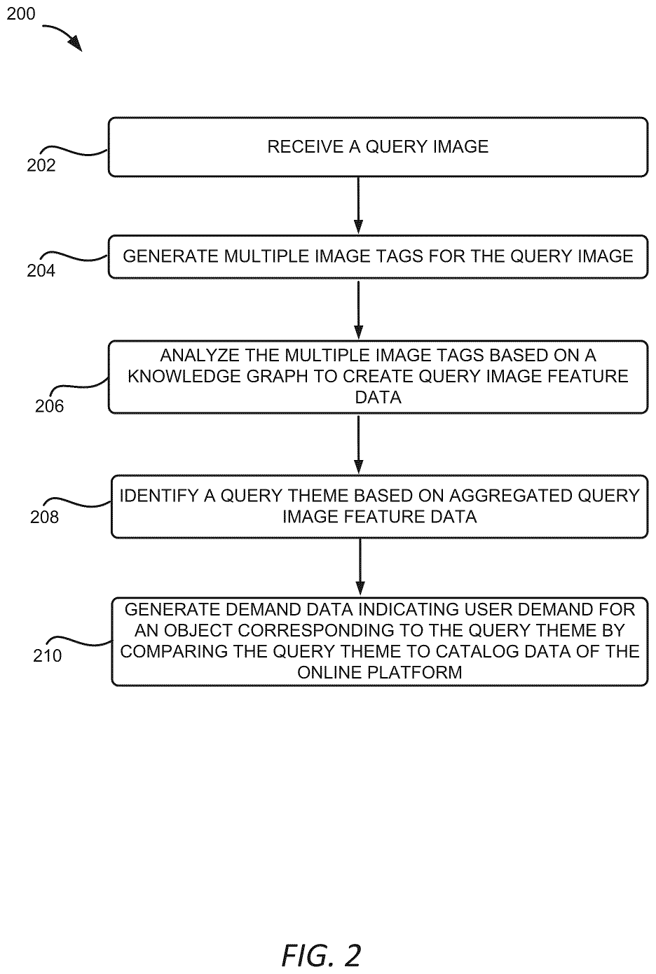

FIG. 2 depicts an example of a process 200 for detecting user demand based on query images 125, according to certain embodiments of the present disclosure. The description of FIG. 2 contemplates process 200 being performed by a demand detection server 102, as described above. However, the process 200 could alternatively be performed by the online platform 136, for example by executing the described modules on the platform server 138 and storing the associated data in the online platform database 140.

At block 202, an image tagging module 106 receives a query image 125. In some examples, the query image 125 is retrieved from query image data 126 stored in a data store 124. In some examples, the image tagging module receives one or more query images from an online platform 136, where a query image generation module 150 is configured to generate query images based on user input, generally as described in FIG. 1.

At block 204, the image tagging module 106 generates multiple query image tags 128 that identify and described the contents of the query image 125. In some examples, the image tagging module 106 implements an AI-based object recognition model to recognize the elements in the one or more query images 125. The elements can include objects (or entities) and associated attributes. Objects can be persons, places, or things. The attributes can be object names, object categories, object features such as colors, shapes, actions, emotions, etc. In some examples, the image tagging module 106 extracts image tags based on data associated with the query image 125, such as data about changes the user requested to an original query image (e.g., by providing new prompts or other input for generating a new query image 125 that reflects changes to certain parts of an object shown in the original query image) or direct user feedback regarding the query image 125 (e.g., favoriting, liking or disliking the query image).

At block 206, an image content analyzer module 108 analyzes the multiple image tags based on a knowledge graph 142 to create query image feature data 130. The online platform 136 can be a marketplace platform offering products in commerce. The knowledge graph 142 can be an e-commerce knowledge graph including product information for a variety of products, either currently offered on the online platform 136 or not. The knowledge graph 142 can be generated by the online platform 136 or a third-party platform and is accessible via an API by the demand detection server 102 or the online platform 136. The image content analyzer module 108 maps the query image tags 128 generated for one or more query images 125 by the image tagging module 106 to the knowledge graph 142 to determine a semantic context of the multiple image tags based on the knowledge graph. for example, the image content analyzer module 108 can determine if an image tag refers to a product, an attribute of a product such as measure or color, or a subpart of a larger item. Also for example, the image content analyzer module 108 can determine one or more category names for the object depicted in the query image. The query image feature data streamlines and enriches the image tags. For example, from image tags for a query image include “rubber duck” and “yellow,” query image feature data, including “rubber duck” can also be called “rubber duckie,” “yellow” is the color of the “rubber duck”, “rubber duck” belongs to the category of “toys” or “bathtub toys,” and “rubber duckie,” can be inferred and created from the knowledge graph.

In some examples, the image tagging module 106 and the image content analyzer module 108 process query images 125 associated with multiple user queries from different users during a period of time. The query image feature data 130 for different user queries during the period of time can be aggregated to generate aggregated query image feature data.

At block 208, a theme identification module 120 identifies a query theme 132 based on aggregated query image feature data 130. The theme identification module 120 can use a clustering model to cluster the aggregated query image feature data 130 based on commonalities or similarities. The clustering model can be a connectivity-based model (e.g., hierarchical clustering algorithm), a density-based model (e.g., density-based spatial clustering of applications (DBSCAN)), a distribution-based model (e.g., Gaussian Mixture Model), centroid model (e.g., K-means clustering), or a neural-based model (e.g., unsupervised neural networks). The clustering model can also be a topic extraction model based on Latent Dirichlet allocation (LDA) or other generative probabilistic models. The clustering model can generate one or more clusters for the aggregated query image feature data 130. Each cluster corresponds to a query theme 132 describing the commonalities of the query image feature data 130 in a cluster. The query theme 132 can include information about an object category, an object name, an object attribute, or other object descriptors from the aggregated query image feature data 130.

At block 210, a demand analysis module 122 generates demand data 134 indicating user demand for the object corresponding to the query theme 132 by comparing the query theme 132 to catalog data 144 of the online platform 136. In some examples, the demand analysis module 122 uses a similarity model to compare a query theme 132 and the catalog data 144 of the online platform 136. The similarity model can determine a similarity score to measure the similarity between the query theme 132 and the catalog data 144. For examples, the similarity model determines a cosine similarity between an embedding vector for a query theme 132 and an embedding vector for the catalog data 144. If the similarity score is below a predetermined threshold, the query theme 132 is determined to represent an unmet demand from the online platform 136. The demand analysis module 122 then generates demand data 134 based on the query theme 132 with a similarity score below the predetermined threshold. The demand data 134 can include synthetic object images generated based on the query theme representing the detected demand, no matter the demand has been met or not. The demand data 134 can also include recommendations of products by certain suppliers for the online platform 136 to carry. The demand analysis module 122 transmits the demand data 134 to the online platform 136 or otherwise displays the demand data 134 for viewing by the operator of the online platform 136.

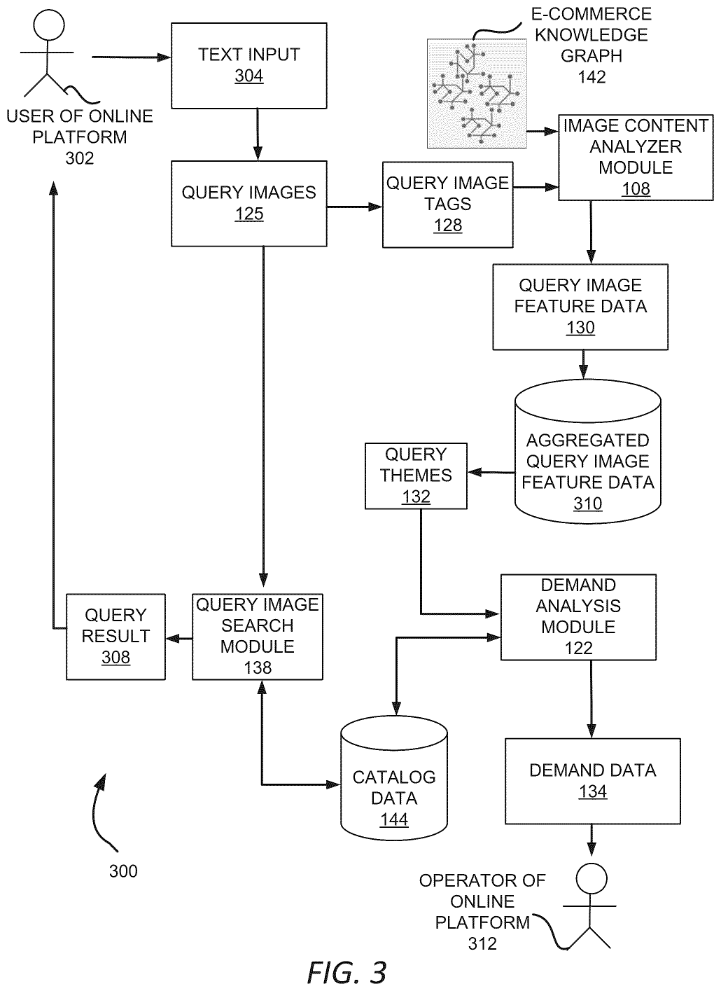

FIG. 3 is an example workflow 300 of detecting user demand for items offered by an online platform 136, according to certain embodiments of the present disclosure. In this example, a user 302 of an online platform 136 enters a text input 304, i.e., a prompt, via a GUI of the online platform 136. In this example, the online platform 136 is a marketplace platform offering products in commerce. The text input 304 includes one or more keywords describing a product of interest that the user 302 is searching for on the online platform 136. A query image generation module 150 on the platform server 138 generates one or more query images 125 based on the text input 304. The user 302 can provide feedback to the one or more query images 125. The query image generation module 150 regenerates the query images 125 based on the user feedback. The platform server 138 also compares the generated/regenerated query images 125 with the catalog data 144, for example by implementing a query image search module 139, to determine if any product offered on the online platform 136 matches or is sufficiently similar to the query images 125 to generate a query result 308. Query results may be displayed to the user in the form of images of certain products that match or are similar to the query images 125. The user can select a product for purchase or provide feedback indicating that none of the suggested products is what the user 302 is looking for.

Meanwhile, the query images 125 (e.g., originally generated and regenerated and associated metadata about user feedback) can be processed by an image tagging module 106 on the demand detection server 102 to generate query image tags 128. The query image tags 128 includes category, name, attributes, or other descriptors about the object depicted in the query images 125. In some examples, the image tagging module 106 compares different versions of the query images 125 in view of the user action metadata to determine query image tags 128 that are important to the user 302. For example, the user 302 chose to keep “cap sleeves” in a shirt image, thus, one of the image tags can include “cap sleeves.”

An image content analyzer module 108 can compare query image tags 128 to an e-commerce knowledge graph 142 to enrich the query image tags based on the e-commerce knowledge graph 142. The e-commerce knowledge graph 142 has its own vocabulary for describing products that can be offered on e-commerce platforms. If a product category included in the query image tags 128 can be mapped to a term used in the e-commerce knowledge graph 142, that term is extracted as an inferred product category. The mapping is based on semantic meanings. One product can belong to more than one category, thus there can be more than one inferred product category. If a product name included in the query image tags 128 can be mapped to a term used in the e-commerce knowledge graph 142, that term is extracted as an inferred product name. Similarly, if a product attribute included in the query image tags 128 can be mapped to a term used in the e-commerce knowledge graph 142, that term is extracted as an inferred product attribute. In addition, the image content analyzer module 108 can also provide context for the query image tags 128. For example, the image content analyzer module 108 determines if a query image tag 128 is referred to as a category, a name, or an attribute of the object in the query images 125 based on the e-commerce knowledge graph 142. The context and the enriched query image tags 128 constitute query image feature data 130 corresponding to the query images 125 associated with the text input 304.

The query image feature data 130 extracted from different query images 125 generated for different users 302 can be aggregated to persisted in storage as aggregated query image feature data 310. The aggregated query image feature data 310 can be processed to derive query themes 132. For example, the theme identification module 120 of the demand detection server 102 implements a cluster model to cluster the aggregated query image feature data 310 into different clusters. The query themes 132 can be trends or patterns identified from the aggregated query image feature data 310.

The identified query themes 132 can be compared with the catalog data 144 of the online platform 136, for example by a demand analysis module 122 on the demand detection server 102, to determine if any products offered on the online platform 136 match the identified query themes 132. If none of the products matches an identified query theme 132, it indicates that there is an unmet need for products corresponding to the identified query theme 132. Alternatively, if certain products match an identified query theme 132, it indicates that the online platform 136 has been meeting user demand for products corresponding to the identified query theme 132. In some embodiments, the demand data 134 (either indicating unmet demand or met demand) can include images showing products that match or are similar to products searched by users. For example, a query theme is pink apparel because 10% of the user queries are about different pink clothes. One or more images of pink apparel (e.g., pink shirts, pink dress) can be generated and included in the demand data 134, which is sent to or displayed for an operator 312 of the online platform 136.

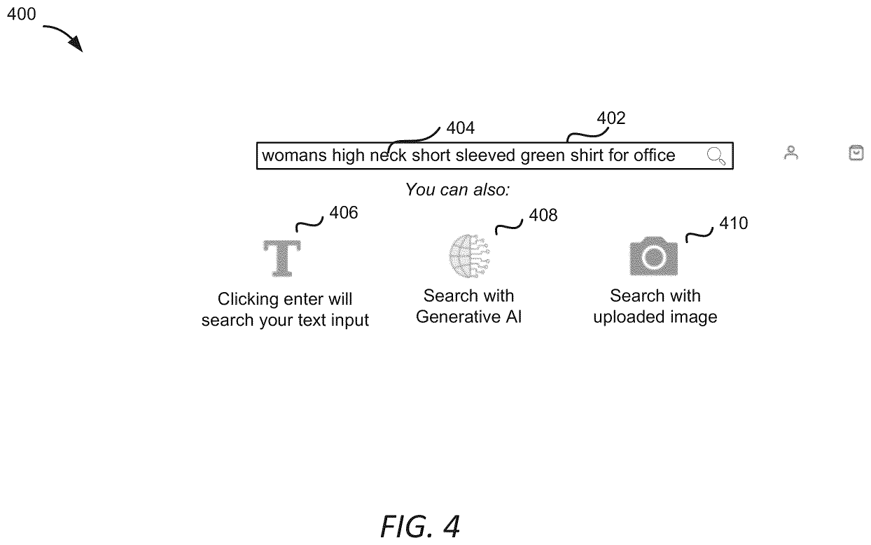

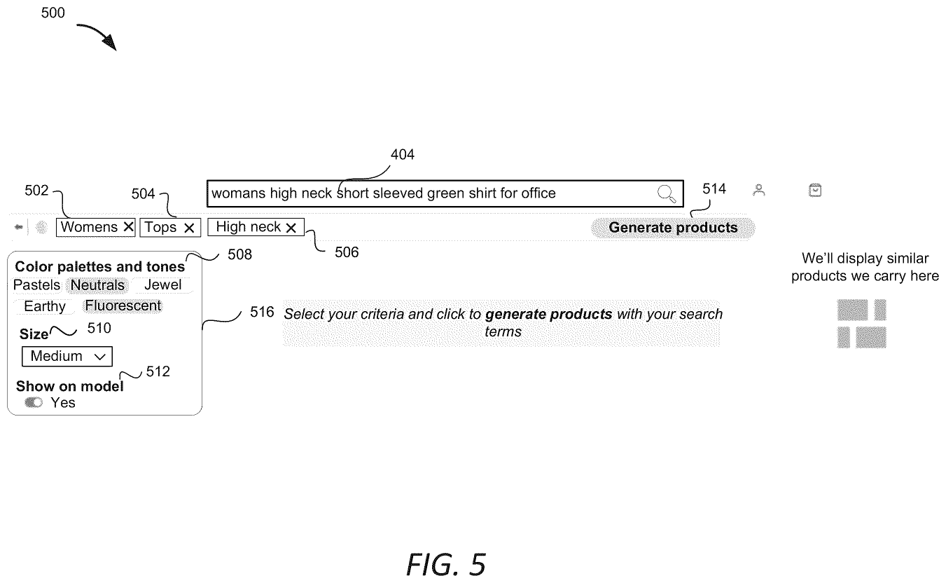

FIG. 4 depicts an example of a GUI 400 for an online platform 136 for entering a user query, according to certain embodiments of the present disclosure. The GUI 400 enables a user to search for any product of interest on the online platform 136. In this example, the online platform 136 is a marketplace platform. A user can enter a query text 404 in search box 402. The query text 404 describes what the user is searching for in the user's words. It may not be the exact term used by the online platform 136. It may not be grammatically correct. In this example, the query text 404 is “womans high neck short sleeved green shirt for office.” The GUI 400 provides three possible search methods. The first one is text-based search 406, where the platform server 138 searches the query text 404 entered in the search box 402 in the catalog data 144 of the online platform 136. The second one is generative AI-based search 408, where the platform server 138 generates one or more query images 125 based on the query text 404 entered in the search box 402 and identify images in the catalog data 144 of the online platform 136 that are similar to the generated query images 125. The third one is uploaded image-based search 410, where a user can upload a query image 125 depicting a product of interest and the platform server 138 searches the catalog data 144 of the online platform 136 to identify products that are similar to the user-uploaded image. In this example, which continues in FIGS. 5-7, a user chooses the generative AI-based search 408 after entering the query text 404.

FIG. 5 depicts an example of a GUI 500 for generating query images 125, according to certain embodiments of the present disclosure. Following the example above, the query image generation module 150 on the platform server 138 is provided with prompts based on the query text 404, for example “women's” 502, “tops” 504, and “high neck” 506. A user can also specify certain criteria for generating query images 125, such as the criteria included in criteria box 516. For example, the user sets the color palettes and tones 508 to be “neutral” and “fluorescent,” sets the size 510 to be “medium,” and selects to “show on model” 512. Any criteria selected by the user are converted to prompts and submitted to the query image generation module 150 along with prompts derived from the query text 404. The user can click or touch the button 514 to submit the prompts and generate query images 125.

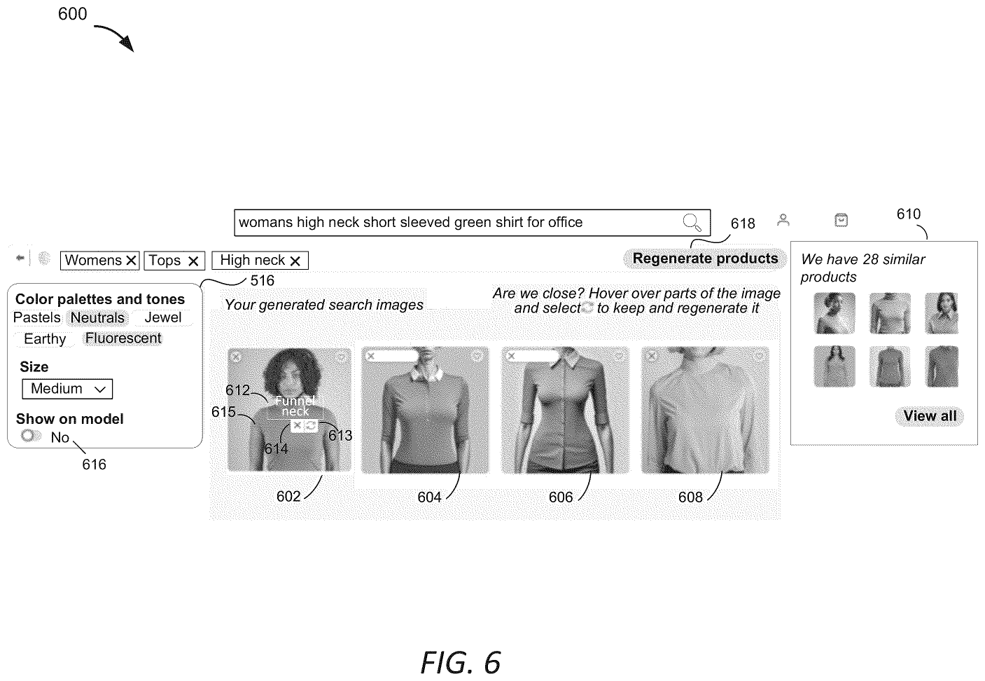

FIG. 6 depicts an example of a GUI 600 for providing feedback on generated query images 125, according to certain embodiments of the present disclosure. Following the example above, after the user clicks or touches the button 514, the query image generation module 150 on the platform server 138 generates four query images 602, 604, 606, and 608. Meanwhile, the query image search module 139 searches the catalog data 144 of the online platform 136 and finds 28 products similar to the generated query images, as shown in region 610. The user can provide feedback about the generated query images 602, 604, 606, and 608, or interact with the similar products displayed in region 610. For example, the user can “heart” certain query images or mark certain query images as “not a match” to what the user has in mind. In FIG. 6, the user marked query images 604 and 608 as “not a match.” The user can also provide feedback to specific parts in a query image. These parts can be generated to be interactive based on the query text 404. A user can hover the cursor over an interactive part and choose to keep or regenerate the interactive part. Note that the name of the interactive part can also be displayed to inform the user. For example, the collar 612 of the shirt shown in query image 602 is interactive and is shown as a “funnel neck.” The user can elect to keep the funnel neck collar by clicking the reuse button 613. Then when the user clicks or presses the regenerate button 618, the regenerated images can keep the funnel neck feature, and provide alternative representations for all other aspects of the generated image. Alternatively, the user can elect to deliberately exclude the funnel neck collar in subsequent image generation by clicking the delete button 614. Then when the user clicks or presses the regenerate button 618, the regenerated images may not include the funnel neck feature but may have a turtleneck or rolled neck or other types of high neck features. Additionally, other aspects of the shirt, such as the sleeve 615 of the shirt shown in query image 602, can be interactive such that a user can elect to keep or exclude that aspect of the shirt. This functionality can also be available for other generated shirts. Meanwhile, the user can update certain criteria in the criteria box 516. For example, the user can deselect the “show on model” option 616, which would result in the query images 602, 604, 606, 608 being regenerated to show the various shirts not worn by models. The user can also click the button 618 to regenerate all query images 602, 604, 606, 608, with or without changing any of the original prompts, such as the query text 404 or other specified criteria. Each time one or more of the query images 602, 604, 606, 608 are regenerated, region 610 is updated to show products that match or are sufficiently similar to the updated set of query images 602, 604, 606, 608.

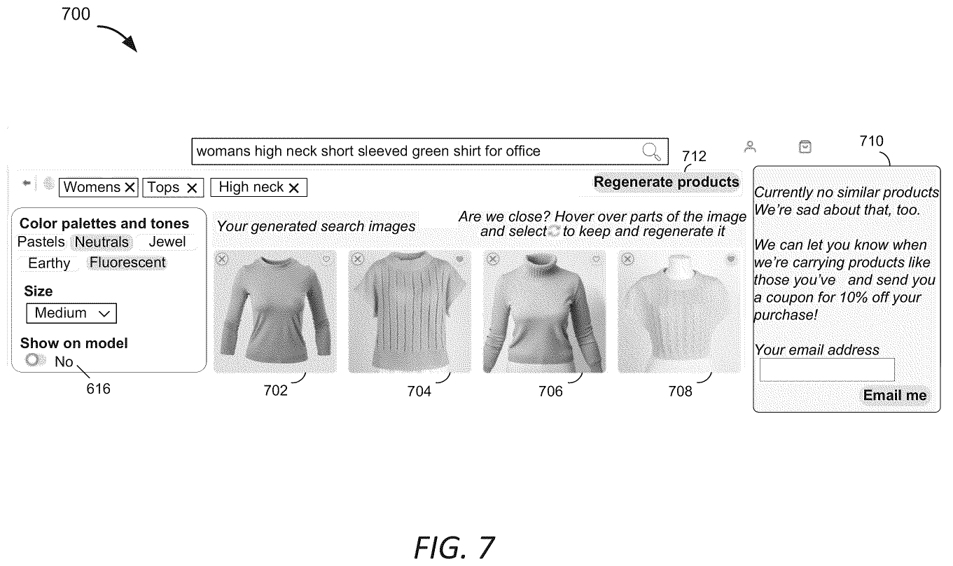

FIG. 7 depicts an example of a GUI 700 showing a case in which the online platform 306 does not offer products that match or are sufficiently similar to generated or regenerated query images. Following the example above, after the user clicks or touches the button 618 (in FIG. 6) to regenerate query images, the query image generation module 150 on the platform server 138 regenerates four images 702, 704, 706, and 708. Meanwhile, the query image search module 139 searches the catalog data 144 of the online platform 136 and does not find any similar products. Thus, there is no similar product shown in region 710. However, region 710 displays a message to the user that the online platform 136 can let the user know when it carries products like those the user “hearted” and also send a 10% coupon.

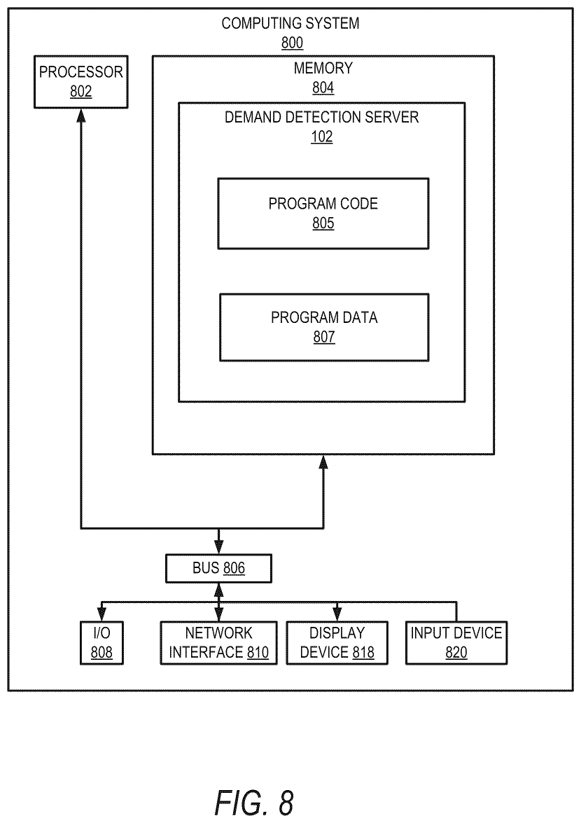

The user can provide feedback about the regenerated query images 702, 704, 706, and 708, similar to the feedback described in FIG. 6. The user can click or touch the button 712 for regenerating query images based on user feedback on the generated query images. In FIG. 7, the user hearted the regenerated images 704 and 708. The query image generation module 150 of the platform server 138 can store user's mark (e.g., a heart symbol indicating the user likes the object depicted in the query image) on regenerated images 704 and 708 and can send a notification to the user when similar products are added to the online platform 136. Any suitable computing system or group of computing systems can be used for performing the operations described herein. For example, FIG. 8 depicts an example of the computing system 800 for implementing certain embodiments of the present disclosure. The implementation of computing system 800 could be used to implement the demand detection server 102. In other embodiments, a single computing system 800 having devices similar to those depicted in FIG. 8 (e.g., a processor, a memory, etc.) combines the one or more operations depicted as separate systems in FIG. 1.

The depicted example of a computing system 800 includes a processor 802 communicatively coupled to one or more memory devices 804. The processor 802 executes computer-executable program code stored in a memory device 804, accesses information stored in the memory device 804, or both. Examples of the processor 802 include a microprocessor, an application-specific integrated circuit (“ASIC”), a field-programmable gate array (“FPGA”), or any other suitable processing device. The processor 802 can include any number of processing devices, including a single processing device.

A memory device 804 includes any suitable non-transitory computer-readable medium for storing program code 805, program data 807, or both. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript.

The computing system 800 executes program code 805 that configures the processor 802 to perform one or more of the operations described herein. Examples of the program code 805 include, in various embodiments, the application executed an image tagging module 106 for generating image tags for the query images, an image content analyzer module 108 for analyzing the image tags based on a knowledge graph associated with an online platform to obtain query image feature data, a theme identification module 110 for identifying query themes based on aggregated query image feature data, a demand detection module 112 for detecting object demand by comparing query themes to catalog data of the online platform to generate object demand data, or other suitable applications that perform one or more operations described herein. The program code may be resident in the memory device 804 or any suitable computer-readable medium and may be executed by the processor 802 or any other suitable processor.

In some embodiments, one or more memory devices 804 stores program data 807 that includes one or more datasets and models described herein. Examples of these datasets include generated query images, query image tags, query image features, query clusters, query themes, detected object demands, etc. In some embodiments, one or more of data sets, models, and functions are stored in the same memory device (e.g., one of the memory devices 804). In additional or alternative embodiments, one or more of the programs, data sets, models, and functions described herein are stored in different memory devices 804 accessible via a data network. One or more buses 806 are also included in the computing system 800. The buses 806 communicatively couples one or more components of a respective one of the computing system 800.

In some embodiments, the computing system 800 also includes a network interface device 810. The network interface device 810 includes any device or group of devices suitable for establishing a wired or wireless data connection to one or more data networks. Non-limiting examples of the network interface device 810 include an Ethernet network adapter, a modem, and/or the like. The computing system 800 is able to communicate with one or more other computing devices (e.g., a user computing device 146) via a data network using the network interface device 810.

The computing system 800 may also include the number of external or internal devices, an input device 820, a display device 818, or other input or output devices. For example, the computing system 800 is shown with one or more input/output (“I/O”) interfaces 808. An I/O interface 808 can receive input from input devices or provide output to output devices. An input device 820 can include any device or group of devices suitable for receiving visual, auditory, or other suitable input that controls or affects the operations of the processor 802. Non-limiting examples of the input device 820 include a touchscreen, a mouse, a keyboard, a microphone, a separate mobile computing device, etc. A display device 818 can include any device or group of devices suitable for providing visual, auditory, or other suitable sensory output. Non-limiting examples of the display device 818 include a touchscreen, a monitor, a speaker, a separate mobile computing device, etc.

Although FIG. 8 depicts the input device 820 and the display device 818 as being local to the computing device that executes the demand detection server 102, other implementations are possible. For instance, in some embodiments, one or more of the input device 820 and the display device 818 can include a remote client-computing device that communicates with the computing system 800 via the network interface device 810 using one or more data networks described herein.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alternatives to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

That which is claimed is:

1. A method performed by one or more processing devices, comprising:
receiving, by an image tagging module, a query image;
generating, by the image tagging module, multiple image tags for the query image, the image tags describing contents of the query image;
analyzing, by an image content analyzer module, the multiple image tags based on a knowledge graph to create query image feature data;
identifying, by a theme identification module, a query theme based on aggregated query image feature data; and
generating, by a demand analysis module, demand data indicating user demand for an object corresponding to the query theme, wherein the demand data is generated by comparing the query theme to catalog data of an online platform.

2. The method of claim 1, wherein the query image is a synthetic image generated by a generative artificial intelligence model.

3. The method of claim 1, further comprising receiving multiple query images associated with a user query on the online platform, wherein the multiple query images comprise image metadata comprising user action data associated with aspects of one or more of the multiple query images.

4. The method of claim 1, wherein the multiple image tags comprise object categories, object names, and object attributes.

5. The method of claim 1, wherein the online platform is a marketplace platform, and wherein the knowledge graph comprises product information for products associated with the marketplace platform.

6. The method of claim 1, wherein the query image feature data comprises inferred semantic descriptions of the multiple image tags, wherein analyzing, by the image content analyzer module, the multiple image tags based on the knowledge graph associated with the online platform to create the query image feature data comprises:
mapping the multiple image tags to the knowledge graph; and
determining a semantic context of the multiple image tags based on the knowledge graph to obtain the inferred semantic descriptions of the multiple image tags.

7. The method of claim 1, further comprising:
aggregating the query image feature data generated from multiple query images corresponding to multiple user queries to generate aggregated query image feature data; and
storing the aggregated query image feature data.

8. The method of claim 1, further comprising transmitting the demand data to the online platform, wherein the demand data comprises a synthetic object image generated based on the demand data.

9. The method of claim 1, further comprising transmitting a to a user computing device a notification message indicating that the object has been newly added to the online platform.

10. A system, comprising:
an image tagging module configured to generate multiple image tags for contents of a query image;
an image content analyzer module configured to analyze the multiple image tags based on a knowledge graph to create query image feature data;
a theme identification module configured to identify a query theme based on aggregated query image feature data; and
a demand detection module configured to generate demand data indicating user demand for an object corresponding to the query theme by comparing the query theme to catalog data of an online platform.

11. The system of claim 10, wherein the demand detection module is further configured to:
determine a query result by comparing the query image associated with a user query to the catalog data of the online platform; and
provide the query result to a user computing device associated with the user query.

12. The system of claim 10, wherein the image tagging module is configured to receive multiple query images associated with a user query on the online platform, wherein the multiple query images comprise image metadata comprising user action data associated with aspects of one or more of the multiple query images.

13. The system of claim 10, wherein the query image feature data comprises inferred semantic descriptions of the multiple image tags, wherein the image content analyzer module is further configured to:
map the multiple image tags to the knowledge graph; and
determine a semantic context of the semantic context of the multiple image tags based on the knowledge graph to obtain the inferred semantic descriptions of the multiple image tags.

14. The system of claim 10, wherein the theme identification module comprises a clustering model configured to cluster the aggregated query image feature data to one or more query clusters, wherein the one or more query clusters correspond to one or more query themes.

15. The system of claim 10, wherein the demand detection module is further configured to transmit the demand data to the online platform, wherein the demand data comprises a synthetic object image generated based on the demand data.

16. A non-transitory computer-readable medium, storing executable instructions, which when executed by a processing device, cause the processing device to perform operations comprising:
receiving one or more query images via an online platform;
generating multiple image tags describing contents of the one or more query images;
analyzing the multiple image tags based on a knowledge graph associated with the online platform to create query image feature data;
identifying a query theme based on aggregated query image feature data; and
a step for generating demand data indicating user demand for an object corresponding to the query theme.

17. The non-transitory computer-readable medium of claim 16, wherein the one or more query images comprises image metadata comprising user action data associated with aspects of the one or more query images.

18. The non-transitory computer-readable medium of claim 16, wherein the executable instructions, which when executed by a processing device, cause the processing device to perform further operations comprising:
determining a query result by comparing the one or more query images to catalog data of the online platform; and
providing the query result to a user computing device associated with user query.

19. The non-transitory computer-readable medium of claim 16, wherein the query image feature data comprises inferred semantic descriptions of the multiple image tags, wherein the executable instructions, which when executed by a processing device, cause the processing device to perform further operations comprising:
map the multiple image tags to the knowledge graph; and
determine a semantic context of the semantic context of the multiple image tags based on the knowledge graph to obtain the inferred semantic descriptions of the multiple image tags.

20. The non-transitory computer-readable medium of claim 16, wherein the executable instructions, which when executed by a processing device, cause the processing device to perform further operations comprising:
transmitting the demand data to the online platform, wherein the demand data comprises a synthetic object image generated based on the demand data.
